(19) United States
(12) Patent Application Publication
(10) Pub. No.: US 2008/0292068 A1
(43) Pub. Date: Nov. 27, 2008

(54) DEVICE AND METHOD OF MACHINE MANAGEMENT VIA A TELECOMMUNICATION NETWORK

(75) Inventor: Raphael BERNHARD, Le Cannet (FR)

Correspondence Address: OBLON, SPIVAK, MCCLELLAND MAIER & NEUSTADT, P.C., 1940 DUKE STREET, ALEXANDRIA, VA, 22314, US

(73) Assignee: FRANCE TELECOM, PARIS (FR)

(21) Appl. No.: 12/124,486

(22) Filed: May 21, 2008

(30) Foreign Application Priority Data
May 25, 2007 (FR) 07 55260

(51) Int. Cl. H04M 1/64

(52) U.S. Cl. 379/87

(57) ABSTRACT

A method of configuring a ring-back tone server associated with a machine capable of communicating via a telecommunication network, comprising:
reception by said ring-back tone server, from said machine, of an information signal including an identifier representative of a state of said machine at the moment said information signal was emitted,
configuring the ring-back tone server in such a way that a piece of equipment requesting the establishment of a communication link with said machine via said network receives in return in a ring-back tone a sound signal representative of the state indicated by means of said information signal.

### FIELD OF THE INVENTION

The invention relates to the field of telecommunications, and in particular to a device and method of managing at least one machine via a telecommunication network.

### BACKGROUND OF THE INVENTION

The invention relates to the so-called “machine-to-machine” field, more commonly called M2M, in which machines, which are autonomous communicating objects, are dispersed in the environment with which they interact and are remotely managed via a telecommunication network. Said machines must permanently retain their ability to communicate, since if this is lost it is no longer possible to know the state of these machines and in particular it is necessary:
either to wait for the machine to recover its communication ability spontaneously, without knowing whether this situation will recur,

or to intervene physically on the machine, for example by electric restarting, to return said machine into a state where it will again be capable of communicating.

Such an operation may prove very costly and complex if the communicating machine is located in a hostile place (forest, floating buoy, etc.) or in an environment not allowing physical maintenance intervention on the machine. Accordingly, permanently maintaining at least one communication link with said machines is a major issue: ideally, it must always be possible to determine whether the machine is in working order or if it requires maintenance.

For overcoming this problem of knowing the machine's ability to communicate, there is no known solution other than maintaining at least one permanent or at least semi-permanent communication link between a management server and the machine. Thus, for a critical autonomous communicating machine, it is usual to add a second communication link, independent of the main communication link and whose sole function is to carry out administrative operations on the machine when the latter is no longer able to communicate via its main communication link. However, this solution is particularly costly and cannot be used for low-cost autonomous communicating objects, as is often the case in M2M applications.

There is therefore a need for a simple solution that can be used to discover the state of a machine, especially its ability to communicate, including in situations where the communication link between said machine and the associated management server is disrupted.

### SUMMARY OF THE INVENTION

To this end, the object of the invention is a method of configuring a ring-back tone server associated with a machine capable of communicating via a telecommunication network, comprising:
reception by said ring-back tone server, from said machine, of an information signal including an identifier representative of a state of said machine at the moment said information signal was emitted,
configuring the ring-back tone server in such a way that a piece of equipment requesting the establishment of a communication link with said machine via said network receives in return in a ring-back tone a sound signal representative of the state indicated by means of said information signal.

The invention consists in exploiting the possibilities of configuration, inherently available in the telecommunication network, in a ring-back tone server associated with a machine, for signaling and determining the state of a machine. In a configuration phase, a sound signal associated with each of the possible states of the machine is recorded in the ring-back tone server. After this configuration phase, the machine reports its state by sending an information signal identifying a state and therefore a sound signal from among those recorded. The state of the machine can be obtained at any time from the ring-back tone server, irrespective of the ability of the machine to communicate at that precise moment.

In the case of a switched telephone network (GSM or PSTN), in particular it is possible to program the sound information which will be transmitted in the ring-back tone when there is a request for establishing a communication link with the machine. When there is a telephone call in a switched telephone network, the ring-back tone is broadcast independently of the connection state of the called equipment with the telephone network. Thus, it is not necessary for the machine to be in a state of being able to communicate in order to obtain the associated ring-back tone, since it is the telephone network that supplies said ring-back tone. It is therefore possible to set up an interrogation protocol for discovering the state of a machine which does not require the machine concerned to be connected to the telephone network at the time of the interrogation phase.

Given that the invention uses functions inherent to the telecommunication network associated with a communication link used for communicating with the machine, no additional device is necessary for implementing the invention. The invention is accordingly simple and inexpensive to implement.

Preferably, the states reported by the machine are states each corresponding to a stage reached by said machine during the execution of a process. This process is a process of connecting to a network for example.

The object of the invention is also a method of managing at least one machine capable of communicating via a telecommunication network, comprising:
emitting a request for an establishment of a communication with said machine via said network,
reception, in a ring back tone received in response to said request, of a sound signal representative of a state of said machine,

wherein said state is a state of said machine at the moment an information signal including an identifier representative of said state was emitted to a ring-back tone server to control the configuration of the ring-back tone associated to said machine.

Setting up an interrogation protocol such as that described above can be used in this instance to determine the latest state reported by the machine, and accordingly, the latest step correctly performed by the machine during its attempt to connect to the network. This information is obtained without having to communicate with the machine, whether or not the machine is ultimately capable of communicating. It is possible to establish a diagnosis of the state of the machine based on the state information received, and in particular to determine whether or not a maintenance operation is necessary on said machine.

According to a preferred implementation, the different steps of the method according to the invention are implemented by a computer program or software, said software comprising software instructions intended to be executed by a data processor of the ring-back tone server and designed for controlling the execution of the different steps of said method.

Consequently, the invention also relates to a program, capable of being executed by a computer or by a data processor, said program comprising instructions for controlling the execution of the steps of a method such as that mentioned above.

Said program may use any programming language and be in the form of source code, object code, or intermediate code between source code and object code, such as in a partially compiled form, or in any other desirable form.

The invention also relates to an information medium, capable of being read by a computer or data processor, including instructions for a program such as that mentioned above.

The information medium may be any entity or device capable of storing the program. For instance, the medium may comprise a means of storage, such as a ROM, for example a CD ROM or a microelectronic circuit ROM, or a means of magnetic recording, for example a diskette (floppy disk) or a hard disk.

Secondly, the information medium may be a transmissible medium such as an electrical or optical signal, which can be carried via an electrical or optical cable, by radio or by other means. The program according to the invention may in particular be downloaded on an Internet type network.

Alternatively, the information medium may be an integrated circuit incorporating the program, the circuit being adapted for executing or for being used in the execution of the method in question.

The object of the invention is also a machine capable of communicating via a telecommunication network, comprising means for sending via said network to a ring-back tone server an information signal including an identifier representative of a state of said machine at the moment said information signal was emitted, said information signal being intended to control the configuration of the ring-back tone server in such a way that a piece of equipment requesting the establishment of a communication link with said machine via said network, receives in return in a ring-back tone a sound signal representative of the state indicated by means of said information signal.

The object of the invention is also a ring-back tone server, capable of communicating via a telecommunication network, comprising,
means of reception, from a machine, of an information signal including an identifier representative of a state of said machine at the moment said information signal was emitted,
means of configuring said ring-back tone server in such a way that a piece of equipment requesting the establishment of a communication link with said machine via said network receives in return in a ring-back tone a sound signal representative of the state indicated by means of said information signal.

The object of the invention is also a device for managing at least one machine, capable of communicating via a telecommunication network, comprising,
means for transmitting a request for establishing a communication link with said machine via said network,
means for reception and analysis of a sound signal, received in response to said request in a ring-back tone and representative of a state of said machine,

wherein said state is a state of said machine at the moment an information signal including an identifier representative of said state was emitted to a ring-back tone server to control the configuration of the ring-back tone associated to said machine.

The advantages described for the method according to the invention are transposable to these different devices cooperating in the implementation of the invention, namely the telecommunication server, the management device and the machine according to the invention.

### BRIEF DESCRIPTION OF THE DRAWINGS

Other objects, characteristics and advantages of the invention will appear through the following description, given solely by way of a non-restrictive example, and referring to the attached drawings, in which:

FIG. 1 schematically represents a telecommunication system for implementing the invention;

FIG. 2a shows the first and second phases of the method according to the invention in the form of a flowchart;

FIG. 2b shows the third phase of the method according to the invention in the form of a flowchart.

### DETAILED DESCRIPTION OF THE INVENTION

The invention is applicable to any type of communicating machine, whether a communication terminal, or machines such as sensors, actuators, drink dispensers, electric meters, etc.

The invention is also applicable to a particular type of machine, namely GPRS gateways. These gateways are used for example for establishing a communication bridge between physical sensors (temperature sensors, geographical location sensor, etc.) and a remote application that collects the information coming from these different sensors. Such gateways should preferably be completely autonomous and not require any human intervention.

The invention is described in further detail as part of an example of application to such a gateway.

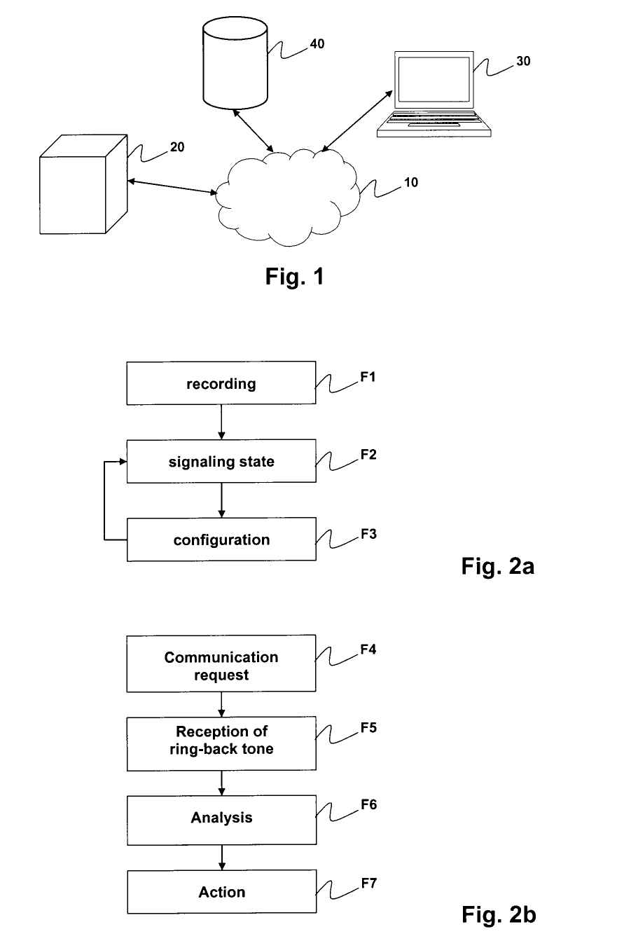

The different elements cooperating in the implementation of the invention are shown schematically in FIG. 1. These different elements are capable of communicating via a telecommunication network 10, which in this instance is a GSM (Global System for Mobile communication)/GPRS (General Packet Radio Service) network.

These elements are:
an autonomous communicating machine 20, equipped with a GPRS modem associated with a telephone number, +33611111111 for example;
a telecommunication server 40, equipped with a network 10 connection module associated with a telephone number, +33777 for example, and which can be used to program the ring-back tones of at least one part of the equipment connected to the network 10, in particular the ring-back tone of the machine 20;
a remote management application 30, deployed in a management server equipped with a network 10 connection module and capable of establishing a communication link with the machine 20 via the network 10.

The communicating machine 20 is, in the example described, a GPRS gateway.

In the event of a software or hardware fault in the platform, it is no longer possible to establish a communication link with it. In particular, it is no longer possible to know its state, nor to determine whether an update of the onboard software in the gateway is necessary or whether an intervention is necessary on the gateway's hardware. The invention answers this problem.

The different steps of the method according to the invention are shown schematically in FIGS. 2a and 2b.

In a first phase of the method according to the invention, called the configuration phase, a plurality of sound signals to be used by the telecommunication server 40 are recorded, each of the signals being respectively associated with a state of said machine. Thus a sound signal is representative of one the identified states of the machine 20. This configuration phase corresponds to step F1 in FIG. 2a.

In a second phase of the method according to the invention, called the signaling phase, the machine 20 reports its new current state by sending an information signal to the telecommunication server 40 at step F2. Said information signal includes coded information used to identify a sound signal from among those recorded by the telecommunication server 40. The coded information includes for example an identifier representative of the current state of the machine, the identified sound signal being the sound signal associated with the current state of the machine 20.

On receiving said information signal, the telecommunication server 40 stores at step F3 the coded information transmitted and proceeds to a configuration step in such a way that a piece of equipment requesting the establishment of a communication with the gateway via the network 10, receives in return, in the ring-back tone transmitted to the equipment, the sound signal recorded in association with the state indicated by means of the information signal.

The configuration mechanism of the telecommunication server 40 is based on an existing dialing mechanism in the telecommunication network 10.

Thus, for reporting its state, by means of its modem the machine dials a specific number corresponding to this state. The number dialed by the machine is composed for example of the sequence “ATDT+33777,01”, in which:
“ATDT” is a command generally recognized by modems, corresponding to a dialing order;
“+33777” is the telephone number of the telecommunication server 40 enabling the configuration of ring-back tones for the machine 20,
“,” is a break character for separating the dialing part from the command part;
“01” is the information signal itself, in the form, for example, of a DTMF (Dual Tone Modulation Frequency) signal, this signal being indicative of the current state of the machine.

Following step F3 of configuration of the telecommunication server 40, the ring-back tone associated with the telephone number of the machine 20 is therefore that corresponding to the state identified by the code “01”.

Each time that the machine 20 takes on a state from among a predetermined list of states, the machine sends a new information signal to the telecommunication server 40, steps F2 and F3 being executed again according to what has just been described.

In a third phase of the method according to the invention, called the operating phase, the management application or a user determines the state of the gateway.

This state can very easily be consulted by a user, a physical person, who at step F4 dials the telephone number of the machine (+33611111111) on his telephone, so as to establish a telephone link with the machine 20. In this case, the different sound signals used in the ring-back tone are preferably each in the form of a voice message intelligible to a human being. By simply listening to the voice message received in the ring-back tone at step F5, in response to the request for establishing the telephone link with the machine 20, the person determines that the machine is in the state indicated by the voice message.

This state can also be obtained very easily by a computer application which at step F4 automatically dials the telephone number of the machine and which recognizes, via appropriate signal processing techniques, the sound information received at step F5 in the ring-back tone in response to the request for establishing the telephone link with the machine 20. This computer application then proceeds at step F6 to the analysis of the signal received so as to determine the state of the machine associated with said signal.

For simplifying the computer analysis of the sound messages, these are advantageously coded in the form of DTMF sound signals since a considerable amount of equipment using the telecommunication network already has electronic circuits capable of recognizing DTMF signals.

At step F7, following the analysis of the sound signal received, the computer application is capable of determining if an action has to be performed with regard to the machine 20, for example: remote maintenance operation, on-site maintenance operation, sending a warning message, recording the state of the machine, etc.

In the event that the machine 20 is, for one reason or another, disconnected from the network 10, the information on the state of the machine 20 remains available, since by calling the telephone number of the machine, the telecommunication network will continue to broadcast the programmed sound information.

By way of illustration, the different steps are described of a process implemented by a GPRS gateway during a software update of said gateway.

The process is initiated following the reception by the gateway of a request for updating its software.

At step E1: the gateway receives a new version of its onboard software and starts downloading the software: it sends (step F2) the information signal ATDT+33777,06 associated with the voice message “software download” to the telecommunication server 40. At this stage, the machine is in a state where it can communicate using GSM, SMS and GPRS.

At step E2: at the end of downloading, the gateway restarts spontaneously. It programs the state “00” just before restarting: it sends (step F2) the information signal ATDT+33777,00 associated with the voice message “spontaneous restart” to the telecommunication server 40. At this stage, the machine is in a state where it can communicate neither in GSM, nor in SMS nor in GPRS.

At step E3: at the beginning of restarting, as soon as the GSM network is activated, the gateway sends (step F2) an information signal to the telecommunication server 40 reporting that it is in the process of restarting: it sends the information signal ATDT+33777,01 associated with the voice message “restart in progress”. At this stage, the machine is in a state where it can communicate in GSM and SMS: the gateway is capable of dialing on the GSM network, it is not yet able to communicate in GPRS. Since the gateway start-up is not finished, this transmission of information is preferably done very early in the restart process. In addition, different successive information signals can be sent during the restart process so as to differentiate different sub-states of the gateway during its restart.

At step E4: at the end of starting, the gateway enters into a nominal state: it sends (step F2) the information signal ATDT+33777,02 associated with the voice message “nominal state” to the telecommunication server 40. At this stage, the machine is in a state where it can communicate in GSM and SMS, the gateway not yet having set up its GPRS context.

At step E5: the gateway receives an SMS requesting it to set up its GPRS link then sets up this link: it sends (step F2) the information signal ATDT+33777,03 associated with the voice message “GPRS active” to the telecommunication server 40. At this stage, the machine is in a state where it can communicate in GSM, SMS and GPRS. In certain circumstances it is impossible to communicate in GPRS with a piece of equipment, even though the GPRS link is correctly set up (routing problem, firewall, etc.). The fact of reporting the state of the machine after setting up the GPRS link enables a verification procedure to be initiated in a management device, in order to verify that the GPRS context has been correctly activated by the gateway.

If, after executing the update process, the gateway does not respond normally to sending an SMS short message via the GPRS network, it is probable that this process has taken place abnormally. It is then possible to discover the latest state reported by the gateway by simply dialing the telephone number of the gateway on an ordinary telephone.

Various cases of error are described that may occur during the restart process described above.

In the case where the restart process is interrupted immediately, the gateway being blocked for example because one of the programs that it runs is corrupted, the gateway is then totally inoperative. The telephone call on the gateway's GSM number causes the reception of the “spontaneous restart” message which means that the “restart in progress” state has not been reached. It is thereby deduced that no remote action is possible on the gateway and a physical intervention is probably necessary.

In the case where the restart has taken place completely correctly, but the gateway cannot be reached via the IP network, calling the GSM number of the gateway causes the reception of the “GPRS active” message. It is deduced thereby that the gateway is connected to the GPRS network and that the communication problem is located in the IP network between the M2M application and the gateway rather than in the operation of the gateway itself.

Steps F2 to F3 of FIG. 2a and F4 to F7 of FIG. 2b, although shown in different figures, are capable of taking place in parallel with one another, since, on the one hand the communicating machine 20 reports its state each time that it takes on a state from a predefined list of states or performs a predefined process (step F2 and following) and, on the other hand, the management application 30 is capable of interrogating (step F4 and following) the network 10 at any time to discover the latest state reported by the communicating machine 20.

The invention is widely applicable to any type of process carried out by the machine 20, the latter reporting different stages in progress in the execution of a process each time by means of an information signal associated with the stage reached each time. Said stage in progress corresponds, as the case may be, to the fact that a step, from a list of steps necessary to the execution of the process, has been accomplished, will be accomplished or is in the process of being accomplished.

As an alternative, when the gateway executes an iterative process, the gateway emits information signals at a regular interval of time for reporting its state, sending an information signal including not only an indication relating to its state, but also a serial number indicating the number of iterations performed.

What is claimed is:

1. A method of configuring a ring-back tone server associated with a machine capable of communicating via a telecommunication network, comprising:
reception by said ring-back tone server, from said machine, of an information signal including an identifier representative of a state of said machine at the moment said information signal was emitted,
configuring the ring-back tone server in such a way that a piece of equipment requesting the establishment of a communication link with said machine via said network receives in return in a ring-back tone a sound signal representative of the state indicated by means of said information signal.

2. A method of managing at least one machine capable of communicating via a telecommunication network, comprising:
emitting a request for an establishment of a communication with said machine via said network,
reception, in a ring back tone received in response to said request, of a sound signal representative of a state of said machine,
wherein said state is a state of said machine at the moment an information signal including an identifier representative of said state was emitted to a ring-back tone server to control the configuration of the ring-back tone associated to said machine.

3. The method as claimed in claim 2 including a step of analysis of the sound signal received in order to determine said state.

4. The method as claimed in claim 1 or 2, in which said state corresponds to a stage reached by said machine during the execution of a process.

5. The method as claimed in claim 4, in which said process is a process of connection to said network.

6. A machine capable of communicating via a telecommunication network, comprising means for sending via said network to a ring-back tone server an information signal including an identifier representative of a state of said machine at the moment said information signal was emitted,
said information signal being intended to control the configuration of the ring-back tone server in such a way that a piece of equipment requesting the establishment of a communication link with said machine via said network, receives in return in a ring-back tone a sound signal representative of the state indicated by means of said information signal.

7. A ring-back tone server, capable of communicating via a telecommunication network, comprising,
means of reception, from a machine, of an information signal including an identifier representative of a state of said machine at the moment said information signal was emitted,
means of configuring said ring-back tone server in such a way that a piece of equipment requesting the establishment of a communication link with said machine via said network receives in return in a ring-back tone a sound signal representative of the state indicated by means of said information signal.

8. A device for managing at least one machine, capable of communicating via a telecommunication network, comprising,
means for transmitting a request for establishing a communication link with said machine via said network,
means for reception and analysis of a sound signal, received in response to said request in a ring-back tone and representative of a state of said machine,
wherein said state is a state of said machine at the moment an information signal including an identifier representative of said state was emitted to a ring-back tone server to control the configuration of the ring-back tone associated to said machine.

9. A computer program comprising program code instructions programmed for executing the steps of the method as claimed in claim 1, when said program is executed by a data processor.

10. A recording medium readable by a data processor on which is recorded a program including program code instructions for executing the steps of the method as claimed in claim 1.

11. A computer program comprising program code instructions programmed for executing the steps of the method as claimed in claim 2, when said program is executed by a data processor.

12. A recording medium readable by a data processor on which is recorded a program including program code instructions for executing the steps of the method as claimed in claim 2.
